(19) United States
(12) Patent Application Publication
(10) Pub. No.: US 2004/0000454 A1
(43) Pub. Date: Jan. 1, 2004

(54) Disc brake system

(75) Inventors: Huang-Tsang Chang, Dayton, OH (US); John A. Hart, Middletown, OH (US)

Correspondence Address: Scott A. McBain, DELPHI TECHNOLOGIES, INC., Legal Staff Mail Code: 480-414-420, P.O. Box 5052, Troy, MI, 48007-5052, US

(73) Assignee: Delphi Technologies, Inc.

(21) Appl. No.: 10/185,900

(22) Filed: Jun. 28, 2002

(51) Int. Cl. F16D 55/36

(52) U.S. Cl. 188/71.5

(57) ABSTRACT

A multi-disc brake assembly has a hub that is rotatable about an axis with at least a pair of discs supported on the hub for relative axial movement along the hub. The discs present braking surfaces for a plurality of friction elements to move into and out of frictional braking engagement therewith. A non-rotatable support structure releasably supports at least one hanger member to slidably support the friction elements. Releasing at least one hanger member from the non-rotatable support structure provides for removal of at least one of the friction elements from the disc brake assembly while the inner caliper portion remains attached to the outer caliper portion. Additionally, at least two bores may be formed in the non-rotatable support structure in generally axially opposed relation to one another. Piston members are disposed in the piston bores for movement toward and away from one another causing frictional braking engagement with the braking surfaces.

### BACKGROUND OF THE INVENTION

1. Field of the Invention

The invention relates generally to disc brake assemblies for vehicles, and more particularly to disc brake assemblies having axially slidable discs.

2. Related Art

A disc brake assembly typically includes a knuckle body having a caliper fastened thereto by a pair of fasteners. A pair of brake pads typically have through holes for receiving the fasteners that attach the caliper to the knuckle body to slidably fix the brake pads to the assembly. In order to replace the brake pads in service, the fasteners that attach the caliper to the knuckle body must be removed, thereby disassembling the caliper from the knuckle body. With the caliper separated from the knuckle body, the brake pads can be replaced, and then the caliper must be reassembled to the knuckle body. Removal of the caliper from the knuckle body requires extensive time and labor, thereby adding to the complexity and expense of changing the brake pads in service.

The caliper typically has a piston bore for receiving a sufficiently large piston member capable of generating enough force against the disc to facilitate braking of a vehicle. The piston member typically resides on one side of the disc an is operable to move outwardly from the caliper to engage a brake pad. The brake pad is caused to move in one direction sufficiently far enough to frictionally engage the disc. This requires the piston to have a relatively large stroke movement in order to generate the required frictional engagement with the disc to facilitate braking of the vehicle. Additionally, the caliper must be capable of applying a sufficiently large force in one direction to generate the necessary frictional engagement between the brake pad and the disc to stop the vehicle.

### SUMMARY OF THE INVENTION

A multi-disc brake assembly embodying the current invention provides for a quick and efficient way to change friction elements within the assembly while providing piston members generally axially opposite one another to enhance the braking performance of the disc brake assembly. One currently preferred embodiment has a hub that is rotatable about an axis with at least a pair of discs supported on the hub for relative axial sliding movement along the hub. The discs have opposite sides presenting braking surfaces for a plurality of friction elements to move into and out of frictional braking engagement therewith. A non-rotatable support structure has a knuckle portion supporting an inner caliper portion and includes an outer caliper portion attached to the inner caliper portion. The non-rotatable support structure releasably supports at least one hanger member that slidably supports the friction elements for axial sliding movement into and out of frictional braking engagement with the braking surfaces. Removal of at least one hanger member from the non-rotatable support structure provides for removal of at least one of the friction elements from the disc brake assembly while the outer caliper portion remains attached to the inner caliper portion.

Another aspect of a currently preferred embodiment of the invention enhances the braking performance of the disc brake assembly by having at least two piston bores formed in the non-rotatable support structure in generally axially opposed relation to one another. The piston members are disposed in each of the piston bores for movement toward and away from one another for causing the friction elements to move into and out of the frictional braking engagement with the braking surfaces.

One advantage of the invention is that the friction elements can be quickly and easily changed without having to disassemble the knuckle and caliper portions.

Another advantage of the invention is that the relative axial movement between the discs and hub is reduced.

Another advantage of the invention is that the stroke of the piston members is reduced.

Another advantage of the invention is that the size of the piston members may be reduced.

Another advantage of the invention is that the friction elements move into uniform frictional engagement with the discs, thus improving the wear characteristics of the discs and the frictional elements.

Another advantage of the invention is that the disc brake assembly may employ greater braking forces, thus increasing the range of vehicle platforms for which it may be used.

Another advantage of the invention is that the structural integrity of the disc brake assembly is enhanced, thereby extending the useful life of the assembly.

### BRIEF DESCRIPTION OF THE DRAWINGS

These and other features and advantages of the present invention will become more readily appreciated when considered in connection with the following detailed description and appended drawings, wherein:

FIG. 1 shows an exploded isometric view of a disc brake assembly embodying a currently preferred embodiment of the invention having a pair of hanger members and opposing piston members in combination with discs that are axially slidable along an axis of a hub;

FIG. 2 shows a partial top view of the disc brake assembly from FIG. 1 while in a disengaged position;

FIG. 3 shows a partial cross-sectional view of the disc brake assembly of FIG. 2;

FIG. 4 is a view similar to FIG. 3 showing the disc brake assembly in an engaged position; and

FIG. 5 shows a partial cross-sectional view of an alternate embodiment of the disc brake assembly having an external fluid passage.

### DETAILED DESCRIPTION OF THE PREFERRED EMBODIMENT

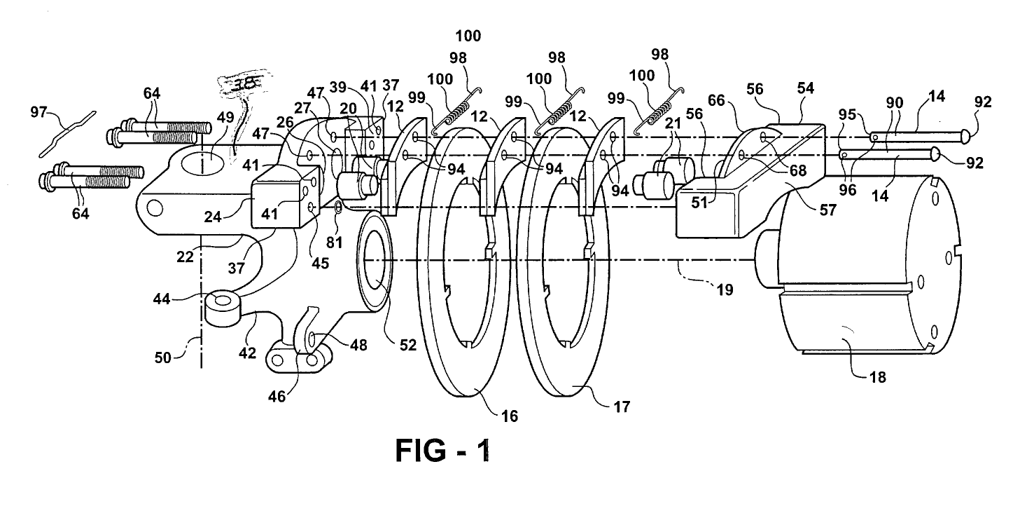

As shown in FIG. 1, a disc brake assembly 10 has a plurality of brake pad assemblies 12 supported by at least one hanger member, shown here as a pair of hanger members 14, 15 for slidable movement thereon. At least one rotor or disc and preferably a pair of discs 16, 17 are supported on a rotatable wheel hub 18 having an axis 19 for slidable movement along the hub 18. The disc brake assembly 10 has at least one piston member and preferably two pairs of axially opposed piston members 20, 21 operable to engage the brake pad assemblies 12 to facilitate frictional engagement of the brake pads with the discs 16, 17.

The disc brake assembly 10 has a knuckle body portion 22 and an inner caliper portion 24 supported by the knuckle body portion 22. The inner caliper portion 24 is shown here as being formed as one piece with the knuckle body portion 22, though this is not necessary, as the inner caliper portion 24 could be attached by fasteners to the knuckle body portion 22 (not shown). The knuckle body portion 22 has an upper arm 38 with a first vertical opening 49 for receiving a strut (not shown), and a lower arm 42 with a second vertical opening 44 for receiving a pin of a ball joint on a tie rod (not shown). Another arm 46 extends laterally from the knuckle body portion 22 having an opening 48 for receiving a track bar (not shown) to provide rotation of the disc brake assembly 10 about an axis 50 for turning a vehicle. Another opening 52 is formed having the axis 19 as its center for rotatably receiving the hub 18 about the axis 19.

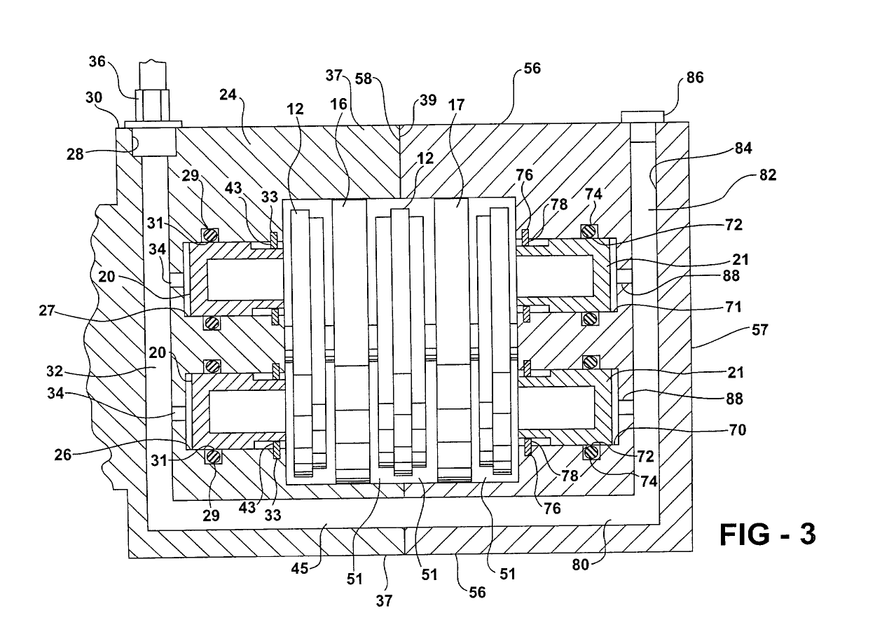

The inner caliper portion 24 has at least one and preferably a pair of piston bores 26, 27 formed therein. As shown in FIGS. 3-5, each piston bore 26, 27 preferably has an annular groove 29 for receiving a seal, shown here as an o-ring 31 and another annular groove 33 for receiving a retaining member, shown here as a snap ring 43. The o-rings 31 preferably remain in constant sealing engagement with the piston members 20 to prevent hydraulic fluid from passing by the o-rings 31, while the snap rings maintain the piston members 20 in their respective piston bores 26, 27.

The inner caliper portion 24 is generally C-shaped having a pair of arms 37 extending laterally outwardly from the knuckle body portion 22. Each arm 37 has an end with a mating surface 39 and preferably a pair of fastener openings or through holes 41 for receiving fasteners 64 therethrough. A first fluid passage 32 having an opening 28 is formed through an external surface 30 of the inner caliper portion 24 and traverses through the inner caliper portion 24 generally perpendicular to the axis 19 of the hub 18. A pair of connecting passages 34 extend between the pair of piston bores 26, 27 in the inner caliper portion 24 and the first fluid passage 32. The connecting passages 34 provide for communication of hydraulic fluid between the first fluid passage 32 and the piston bores 26, 27. A fitting 36 is preferably inserted in the opening 28 of the first fluid passage 32 to facilitate connection of a hydraulic fluid line to the disc brake assembly 10. Another passage 45 is formed generally parallel to the axis 19 through one of the arms 37 and extends from the first fluid passage 32 through the mating surface 39.

An outer caliper portion 54 is generally C-shaped having a pair of arms 56 extending laterally from an abutment portion 57 defining with the inner caliper portion 24 a top opening 51 therebetween for receiving the brake pad assemblies 12. The arms 56 of the outer caliper portion 54 have mating surfaces 58 that abut the mating surfaces 39 of the inner caliper portion 24. Preferably, each arm 56 has a pair of threaded fastener openings (not shown) for receiving a threaded shank 62 on fasteners 64 to releasably attach the outer caliper portion 54 to the inner caliper portion 24 separate from the hanger members 14, 15. At least one piston bore and preferably a pair of piston bores 70, 71 are constructed in the outer caliper portion 54 and are generally opposite to the piston bores 26, 27 formed in the inner caliper portion 24 upon assembly of the outer caliper portion 54 to the inner caliper portion 24. Each piston bore 70, 71 preferably has an annular groove 72 for receiving a seal, shown here as an o-ring 74, and another annular groove 76 for receiving a retaining member, shown here as a snap ring 78. The o-rings 74 remain in constant sealing engagement with the piston members 21 to prevent hydraulic fluid from passing by the o-rings 74, while the snap rings 78 maintain the piston members 21 in their respective piston bores 70, 71.

A passage 80 is preferably formed generally parallel to the axis 19 in one of the arms 56 of the outer caliper portion 54 so that upon assembly of the outer caliper portion 54 to the inner caliper portion 24, the passage 80 coincides with passage 45 to provide for communication of hydraulic fluid between the inner caliper portion 24 and the outer caliper portion 54. To facilitate a seal between the inner and outer caliper portions 24, 54, a seal 81, shown here as an o-ring, can be inserted concentrically to the passages 45, 80 between the inner and outer caliper portions 24, 54.

Another passage 82 is formed in the outer caliper portion 54 generally perpendicular to the axis 19 and intersects passage 80 to provide hydraulic fluid communication between passage 80 and passage 82. The passage 82 has an opening 84 formed in the outer caliper portion 54 which is closed by a plug 86 installed in the opening 84 to prevent hydraulic fluid from exiting the outer caliper portion 54. A connecting passage 88 is constructed to join each piston bore 70, 71 in the outer caliper portion 54 to passage 82, thus providing for hydraulic fluid communication to the piston bores 70, 71.

At least one, and preferably a pair of through holes 47 extend through a hanger support portion in the inner caliper portion 24 for receiving the hanger members 14, 15. An upper flange 66 provides a hanger support portion on the outer caliper portion 54 and has at least one through hole and preferably a pair of through holes 68 for releasably receiving the hanger members 14, 15 to slidably support the brake pad assemblies 12.

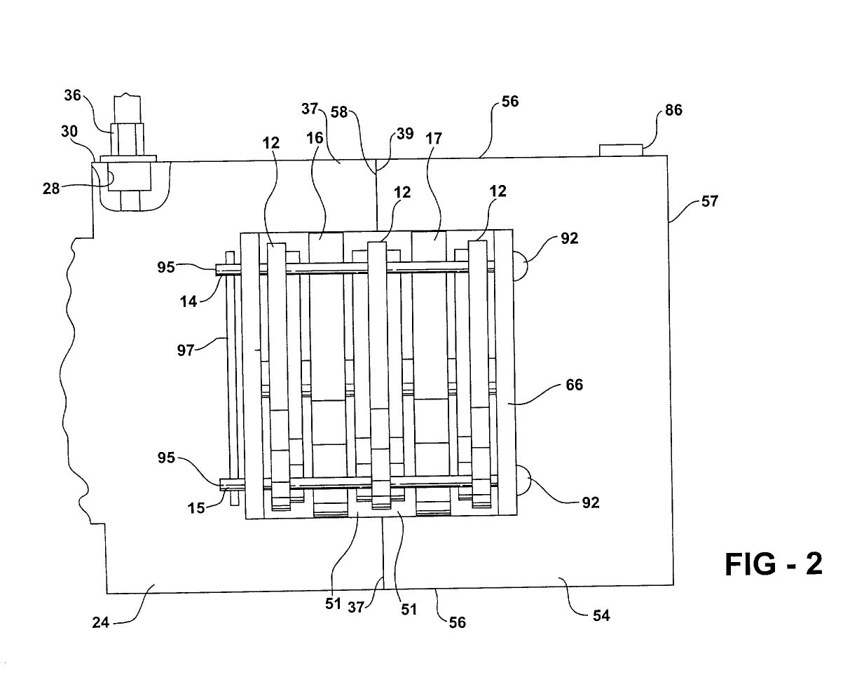

The hanger members 14, 15 have a shank portion 90 for slidably supporting the brake pad assemblies 12 for relative axial movement into and out of frictional braking engagement with the braking surfaces of the discs 16, 17 and a head portion 92. The shank portion 90 is inserted through the through holes 68 in the upper flange 66 of the outer caliper portion 54, through openings 94 in each of the brake pad assemblies 12, and through the through holes 47 in the inner caliper portion 24. An end 95 of each hanger member 14, 15 extends outwardly from the inner caliper portion 24, as best shown in FIG. 2. Each end 95 has an opening 96 passing laterally therethrough wherein a retaining pin 97 is inserted therethrough such that the retaining pin 97 and the head portions 92 on the hanger members 14, 15 act together to releasably retain the hanger members 14, 15 within the inner and outer caliper portions 24, 54. It should be recognized that the hanger members 14, 15 may be formed with any suitable fastening mechanism, such as threaded ends in combination with nuts, ball detents, and that the retaining mechanism need not be limited to a pin style retainer as shown. Additionally, the hanger members 14, 15 may be inserted through the inner caliper portion 24 toward the outer caliper portion 54.

To limit rattling of the brake pad assemblies 12 relative to the discs 16, 17 or the hanger members 14, 15, spring members 98 may be used to create a preload on the brake pad assemblies 12. The spring members 98 are shown here having loops 99 sized to slidably receive each hanger member 14, 15 so that the spring members 98 are retained on the hanger members 14, 15. The spring members 98 have hook portions 100 that wrap over the brake pad assemblies 12 to exert the preload downwardly on the brake pad assemblies 12, thereby supporting the brake pad assemblies 12 against rattling relative to the hanger members 14, 15 and the discs 16, 17. It should be recognized that any suitable spring member may be used as known in the art, and that the spring members need not be limited to the construction shown here.

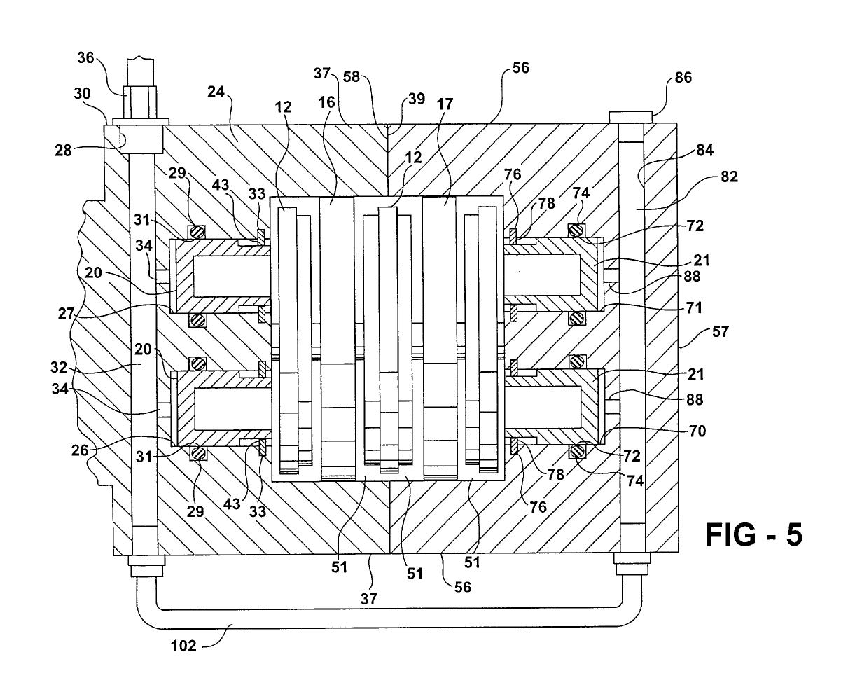

An alternate embodiment of a brake disc assembly according to the invention is shown in FIG. 5. This embodiment is identical to the first embodiment shown in FIGS. 1-4 in all respects, except that the internal passages 45, 80 are replaced by an external passage 102 for communicating hydraulic fluid between the inner caliper portion 24 and the outer caliper portion 54. The remaining structure is identical and thus the same reference numerals are used to designate like parts and features. The external passage 102 is shown here as a tube fabricated from any suitable material such as metal tubing for carrying hydraulic fluid.

### Operation

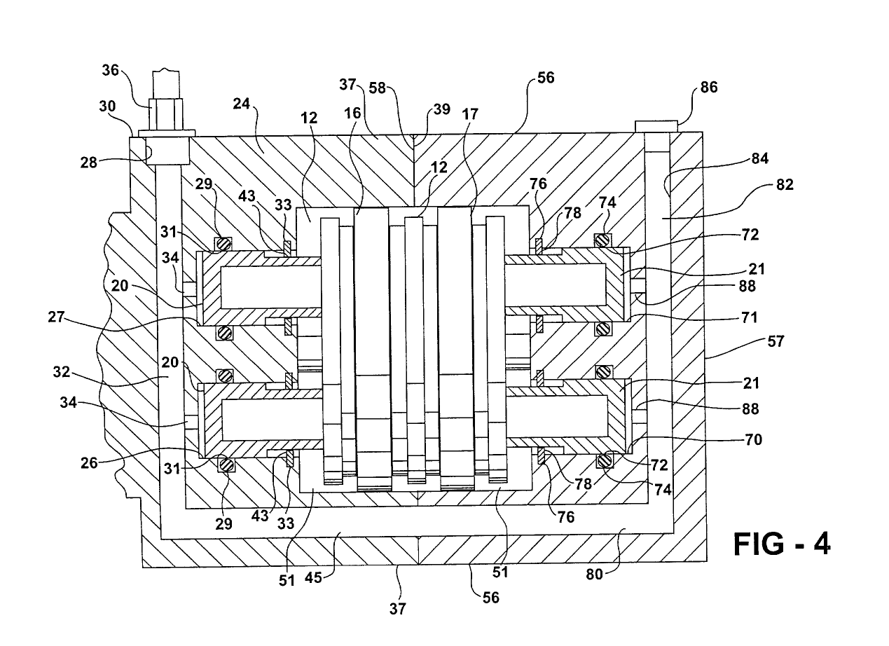

With the disc brake assembly 10 fully assembled and in use, the disc brake assembly 10 has a disengaged position, as shown in FIG. 3, and an engaged position as shown in FIG. 4. In the disengaged position, the hydraulic fluid within the passages 32, 34, 45, 80, 82, 88 and the piston bores 26, 27, 70, 71 remains at or near ambient pressure. Thus, the piston members 20, 21 tend to float relatively freely within their respective piston bores 26, 27, 70, 71 while the brake pad assemblies 12 tend to remain out of frictional engagement with the discs 16, 17. In turn, the discs 16, 17 and the hub 18 are permitted to rotate freely about the axis 19 of the hub 18.

During braking, the hydraulic fluid in the passages 32, 34, 45, 80, 82, 88 and the respective piston bores 26, 27, 70, 71 is pressurized, thereby causing the piston members 20, 21 to move outwardly from the piston bores 26, 27, 70, 71 to engage the brake pad assemblies 12. The brake pad assemblies 12 slide along the hanger members 14, 15 that span the top opening 51 to frictionally engage the discs 16, 17. The frictional engagement of the brake pad assemblies 12 with the discs 16, 17 causes the discs 16, 17 and the hub 18 to resist rotation about the axis 19, thereby slowing the vehicle.

Typically, after extended use, it is desirable to change the brake pad assemblies 12 in the disc brake assembly 10 due to the wear resulting from frictional contact with the discs 16, 17. A relatively quick and easy mechanism is provided to change worn brake pad assemblies 12 by providing hanger members 14, 15 that can be easily removed from the assembly 10 without having to disassemble the outer caliper portion 54 from the inner caliper portion 24.

The hanger pin 97 can be easily removed from the ends 95 of the hanger members 14, 15, thus allowing the hanger members 14, 15 to be slidably removed from the inner and outer caliper portions 24, 54. With the hanger members 14, 15 removed, the brake pad assemblies 12 can be easily lifted from the top opening 51 in the inner and outer caliper portions 24, 54 and from between the discs 16, 17. A set of new brake pad assemblies 12 can then be inserted in the top opening 51 and between the discs 16, 17, and the hanger members 14, 15 can be reinserted to slidably retain the new brake pad assemblies 12 within the disc brake assembly 10.

Being able to quickly and easily change the brake pads in this manner not only helps to reduce the time and expense normally required to change brake pad assemblies, but it also helps to maintain the sealing integrity between the passages 45, 80 in the inner and outer caliper portions 24, 54. By eliminating the need to remove the outer caliper portion 54 from the inner caliper portion 24 to change brake pad assemblies 12, the seal 81 and the mating surfaces 39, 58 are kept from undergoing cyclical stressing, thus preventing undue wear of the seal 81 and the mating surfaces 39, 58. As a result, the ability to maintain a fluid tight seal between the inner and outer caliper members 24, 54 is enhanced. In maintaining a fluid tight seal between the inner and outer caliper portions 24, 54, the useful life of the disc brake assembly 10 is extended.

The braking efficiencies of the disc brake assembly 10 are improved by having axially opposed piston members 20, 21 in combination with axially slidable discs 16, 17. Having axially opposed piston members 20, 21 engaging the discs 16, 17 promotes a more uniform wearing of both the brake pad assemblies 20, 21 and the discs 16, 17, thus preventing non-uniform wear from occurring between and inner diameter and outer diameters of the discs 16, 17. By promoting uniform wear of the discs 16, 17, vibration is prevented that can otherwise be caused by non-uniform wear, especially at elevated rotational speeds of the discs 16, 17. The elimination of vibration is instrumental in enhancing the performance of a vehicle, and in addition, greatly improves the useful life of the disc brake assembly 10, and the vehicle in general. In addition, the stroke of the piston members 20, 21 is reduced by approximately half, thereby reducing potential wear on the associated mating members, as well as reducing the amount of time and pressure required to actuate the piston members 20, 21.

Additionally, by incorporating axially opposed piston members 20, 21 in combination with axially slidable discs 16, 17, a relatively smaller caliper may be used to generate a corresponding amount of braking force as that of a disc brake assembly having either piston members on only one side of the assembly, or having piston members opposite each other in combination with fixed discs. This helps to save on space requirements necessary to accommodate the disc brake assembly 10, thereby facilitating a more flexible vehicle design envelope, and further reducing costs associated in the design and manufacture of a vehicle.

Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A disc brake assembly, comprising:
a hub rotatable about an axis;
at least a pair of discs supported on said hub for rotation therewith and for relative axial sliding movement along said hub and having opposite sides presenting braking surfaces;
a non-rotatable support structure having a knuckle portion, an inner caliper portion supported by the knuckle portion, and an outer caliper portion supported by said inner caliper portion;
a plurality of friction elements; and
at least one hanger member supported by said non-rotatable support structure and slidably supporting at least one of said plurality of friction elements for relative axial sliding movement into and out of frictional braking engagement with at least one of said braking surfaces, said at least one hanger member and said at least one friction element being selectively removable from said non-rotatable support structure while said outer caliper portion remains supported by said inner caliper portion.

2. The disc brake assembly of claim 1 wherein said outer caliper portion is releasably attached to said inner caliper portion by at least one fastener separate from said at least one hanger member.

3. The disc brake assembly of claim 2 wherein said at least one hanger member and said at least one of said plurality of friction elements are releasable from said disc brake assembly while said outer caliper portion remains attached to said inner caliper portion by said at least one fastener.

4. The disc brake assembly of claim 1 wherein said at least one hanger member includes a through hole adjacent an end of said hanger member and a retainer pin removably disposed in said through hole for releasably attaching said at least one hanger member to said non-rotatable support structure.

5. The disc brake assembly of claim 1 wherein said inner and outer caliper portions have a pair of laterally spaced arms defining a top opening in said non-rotatable support structure, said at least one of said plurality of friction elements being removable from said disc brake assembly through said top opening.

6. The disc brake assembly of claim 5 wherein at least one of said arms has a fastener opening in which said at least one fastener is disposed for releasably fastening said outer caliper portion to said inner caliper portion, and said inner caliper portion and said outer caliper portion includes a hanger support formed with a hanger opening in which said at least one hanger member is disposed.

7. The disc brake assembly of claim 6 wherein said at least one hanger member spans said top opening between said inner caliper portion and said outer caliper portion.

8. The disc brake assembly of claim 1 wherein said non-rotatable support structure includes at least two generally axially opposed piston bores and associated piston members disposed in said piston bores.

9. The disc brake assembly of claim 8 including at least one hydraulic fluid supply channel communicating between said at least two piston bores for supplying hydraulic fluid under pressure between said at least two piston bores.

10. The disc brake assembly of claim 9 wherein said at least one hydraulic fluid supply channel is internal to said non-rotatable support structure.

11. The disc brake assembly of claim 9 wherein said at least one hydraulic fluid supply channel is at least partially external to said non-supporting support structure.

12. A disc brake assembly, comprising:
a hub rotatable about an axis;
at least a pair of discs supported on said hub for rotation therewith and for relative axial sliding movement along said hub and having opposite sides presenting braking surfaces;
a non-rotatable support structure;
a plurality of friction elements supported by said non-rotatable support structure for relative axial movement into and out of frictional braking engagement with said braking surfaces; and
at least two piston bores formed in said non-rotatable support structure in generally axially opposed relation to one another and an associated piston member disposed in each of said piston bores for moving said plurality of friction elements selectively into said frictional braking engagement with said braking surfaces.

13. The disc brake assembly of claim 12 wherein said non-rotating support member has a knuckle portion, an inner caliper portion supported by said knuckle portion, and an axially opposed outer caliper portion supported by said inner caliper portion, at least one of said at least two piston bores being formed in said inner caliper portion and at least one other of said at least two piston bores being formed in said outer caliper portion.

14. The disc brake assembly of claim 13 further comprising at least one hydraulic fluid supply channel interconnecting said at least two piston bores in generally axially opposed relation to one another for communicating hydraulic fluid under pressure between said piston bores.

15. The disc brake assembly of claim 14 wherein said at least one hydraulic fluid supply channel is internal to said non-rotatable support structure.

16. The disc brake assembly of claim 14 wherein said at least one hydraulic fluid supply channel is external to said non-rotatable support structure.
